(19) United States
(12) Patent Application Publication
(10) Pub. No.: US 2006/0161854 A1
(43) Pub. Date: Jul. 20, 2006

(54) Method and apparatus for controlling operation of screen saver during reproduction of content

(75) Inventors: Eun-hui Kim, Seoul (KR); Joung-hoon Choo, Seoul (KR); Yong-deok Kim, Asyang-si (KR); Jae-woo Ko, Seongnam-si (KR); Byung-seog Baek, Seongnam-si (KR); Hee-Seok Heo, Gunpo-si (KR); Jae-sung Park, Seoul (KR); Ki-won Kwak, Seongnam-si (KR); Min-woo Jung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/333,509

(22) Filed: Jan. 18, 2006

(30) Foreign Application Priority Data
Jan. 19, 2005 (KR) 10-2005-0005044

(51) Int. Cl. G06F 17/00; G06F 9/00

(52) U.S. Cl. 715/764; 715/867

(57) ABSTRACT

A method and apparatus are provided for controlling the operation of a screen saver during reproduction of content. The method includes the operations of receiving an instruction to reproduce content, checking whether the operation of the screen saver can be controlled, calculating a reproduction time of the content if the operation of the screen saver is controllable, and changing a set time of the screen saver so that the screen saver is not operated during the reproduction time.

### CROSS-REFERENCE TO RELATED APPLICATION

This application claims priority from Korean Patent Application No. 10-2005-0005044 filed on Jan. 19, 2005 in the Korean Intellectual Property Office, the disclosure of which are incorporated herein by reference in their entireties.

### BACKGROUND OF THE INVENTION

1. Field of the Invention

Apparatuses and methods consistent with the present invention relate to controlling operation of a screen saver during reproduction of content.

2. Description of the Related Art

Display devices, such as Plasma Display Panels (PDPs), Liquid Crystal Displays (LCDs), and Digital Televisions (DTVs), are widely used in homes and industry. However, when such a display device outputs a still image for a long time, irregularities in elements constituting the screen may result; this is called “screen burning.” Screen burning directly affects the lifespan of the display devices. Accordingly, in a computer, DTV, notebook or the like, when a still image sustained for a long time is detected, a dynamic image is output or power to the display device is interrupted so that the possibility of screen burning can be reduced.

However, most screen savers operate when there has been no user input. For example, in the case of the computer, a screen saver is executed after a mouse or a keyboard has not been operated for a predetermined time. Meanwhile, in the case of the DTV, a screen saver operates when there has been no input for a predetermined time, that is, a user has not changed the channel of the DTV or has not adjusted the volume thereof using a remote control (Korean Unexamined Pat. Appl. No. 10-2003-94483).

FIG. 1 is a flowchart showing a process of controlling a conventional screen saver. When the system starts or there is external input from a user, the operation of a screen saver is suspended in operation S101. A counter operates while the screen saver is suspended. For example, when an input stand-by time is 10 minutes, a value of 600 is set in the counter and is decremented by one, each second.

Then, in operation S102, it is determined whether an external input has occurred during the previously set time while the countdown is performedoperation. If there has been external input during this time, the counter is reset to 600. If there is no external input during the previously set time, the screen saver starts at operation S103. After the screen saver starts, in operation S104, it is determined whether an external input has occurred. If there has been an external input, the operation of the screen saver is suspended in operation S101. By contrast, if there has been no external input, the screen saver operates continuously.

The method of FIG. 1 is the operational process of most screen savers. However, when a user reproduces specific content, the operation of the screen saver may disturb content viewing. That is, if the set time in FIG. 1 is 30 minutes and the user reproduces content one hour long, the screen saver will be operated during the reproduction of the content if there has been no user input during the reproduction of the content. Accordingly, a method and apparatus are required for controlling the operation of a screen saver during the reproduction of content.

### SUMMARY OF THE INVENTION

An aspect of the present invention resides in controlling the operation of a screen saver during the reproduction of content.

Another aspect of the present invention resides in preventing a user's content viewing from being interrupted by additional input when controlling the operation of a screen saver.

Aspects of the present invention are not limited to the aspects described above, and other aspects not described above will be clearly understood by those skilled in the art from the following descriptions.

According to an aspect of the present invention there is provided a method of controlling the operation of a screen saver during the reproduction of content, the method including the operations of receiving an instruction to reproduce content; checking whether the operation of the screen saver can be controlled; calculating a reproduction time of the content when the operation of the screen saver is controllable; and changing a set time of the screen saver so that the screen saver is not operated during the reproduction time.

According to an aspect of the present invention there is provided an apparatus for controlling the operation of a screen saver during the reproduction of content, the apparatus including a user input unit for receiving an instruction to reproduce content; a reproduction time extracting unit for calculating a reproduction time of the content; a content reproduction unit for reproducing the content; and a screen saver control unit for changing a set time of a screen saver so that the screen saver is not operated during the reproduction time while the content is reproduced, when the reproduction of the content is interrupted.

According to an aspect of the present invention there is provided an apparatus for controlling the operation of a screen saver during the reproduction of content, the apparatus including a user input unit for receiving an instruction to reproduce content; a content reproduction unit for reproducing the content; and a screen saver control unit for operating a screen saver after there has been no input for a predetermined time; wherein the user input unit generates a virtual input signal at intervals of less than that of a set time of the screen saver so that the screen saver is not operated while the content is reproduced.

### BRIEF DESCRIPTION OF THE DRAWINGS

The above and other aspects of the present invention will be more clearly understood from the following detailed description of exemplary embodiments taken in conjunction with the accompanying drawings, in which:

FIG. 1 is a flowchart illustrating a process of controlling a conventional screen saver;

FIG. 2 is a flowchart illustrating a process of controlling a screen saver during the reproduction of content in accordance with an exemplary embodiment of the present invention;

FIG. 3 is an example of extracting the reproduction time of digital broadcast content in accordance with the exemplary embodiment of the present invention;

FIG. 4 is an example of extracting the reproduction time of multimedia data in accordance with the exemplary embodiment of the present invention;

FIG. 5 is an example of extracting the reproduction time of multimedia content in accordance with the exemplary embodiment of the present invention;

FIG. 6 is a flowchart illustrating a process of controlling the screen saver by generating a virtual external input signal during the reproduction of content in accordance with a second exemplary embodiment of the present invention;

FIG. 7 is a flowchart illustrating the entire screen saver process according to the exemplary embodiment of the present invention; and

FIG. 8 is a block diagram showing the components of a multimedia device according to the exemplary embodiment of the present invention.

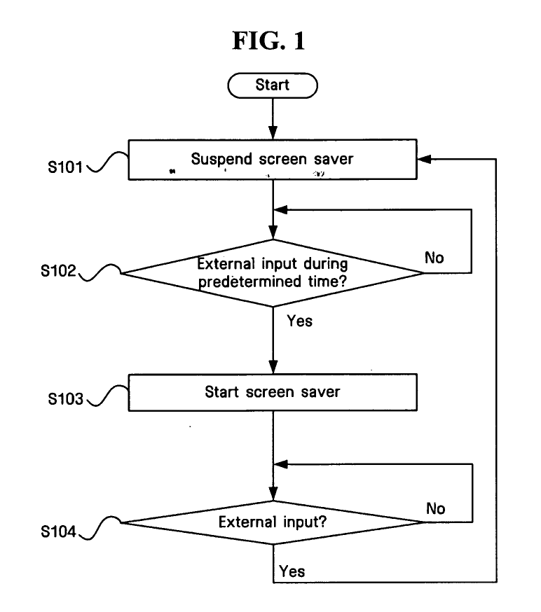

### DESCRIPTION OF THE EXEMPLARY EMBODIMENTS

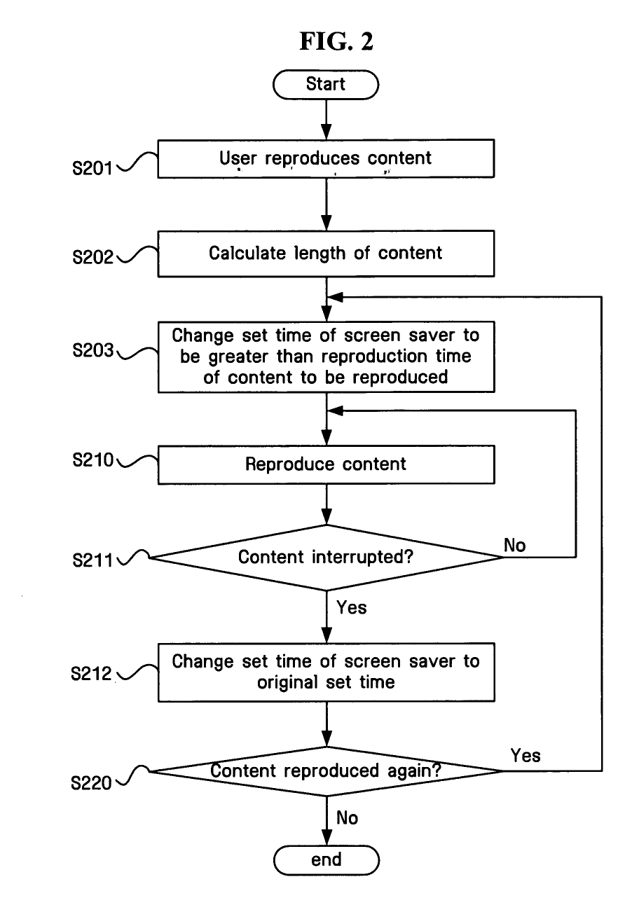

FIG. 2 is a flowchart illustrating a process of controlling a screen saver during the reproduction of content in accordance with an exemplary embodiment of the present invention.

A user selects content and reproduction starts in operation S201. Information about the reproduction time of the content is included in the header of the content. Accordingly, the reproduction time of the content can be calculated in operation S202. Extracting the information about the reproduction time of the content will be described later. The set time of a screen saver is changed to be greater than the reproduction time in operation S203. The set time of the screen saver refers to the time period for which there has been no input or a still image is being displayed, and the screen saver operates after the time period. If the set time of the screen saver is shorter than the reproduction time of the content, there is no need to change the set time of the screen saver to the reproduction time of the content. Since the set time of the screen saver is restored again after the reproduction of the content is paused or completed, it can be changed to the reproduction time of the content regardless of whether the set time of the screen saver is longer than the reproduction time of the content.

After the change, the content is reproduced in operation S210. Operations S203 and S210 may be performed in reverse order. This is because, even though the set time of the screen saver is changed after the reproduction, the overall performance is not influenced by the change. In the case where, during the reproduction of the content, the user pauses the reproduction of the content or moves the reproduction time point forward or backward thereby interrupting the reproduction of the content in operation S211, the set time of the screen saver is set so as to be restored to the original set time in operation S212. Operation S210 is performed when the content is reproduced without interruption.

When the user reproduces the content again in operation S220, the reproduction is performed from operation S203. In operation S203, a calculation is performed using the time point at which the reproduction of the content is started and the time point at which the reproduction of the content is completed, and the difference may be set as the set time of the screen saver. If there is information about the length of one of the packets of the content and information about the location of the portion currently being reproduced in the entire content, that is, information about the amount that has already been reproduced and the amount to be reproduced, this may be converted into a time and then used. If the user is no longer reproducing content, the process is terminated.

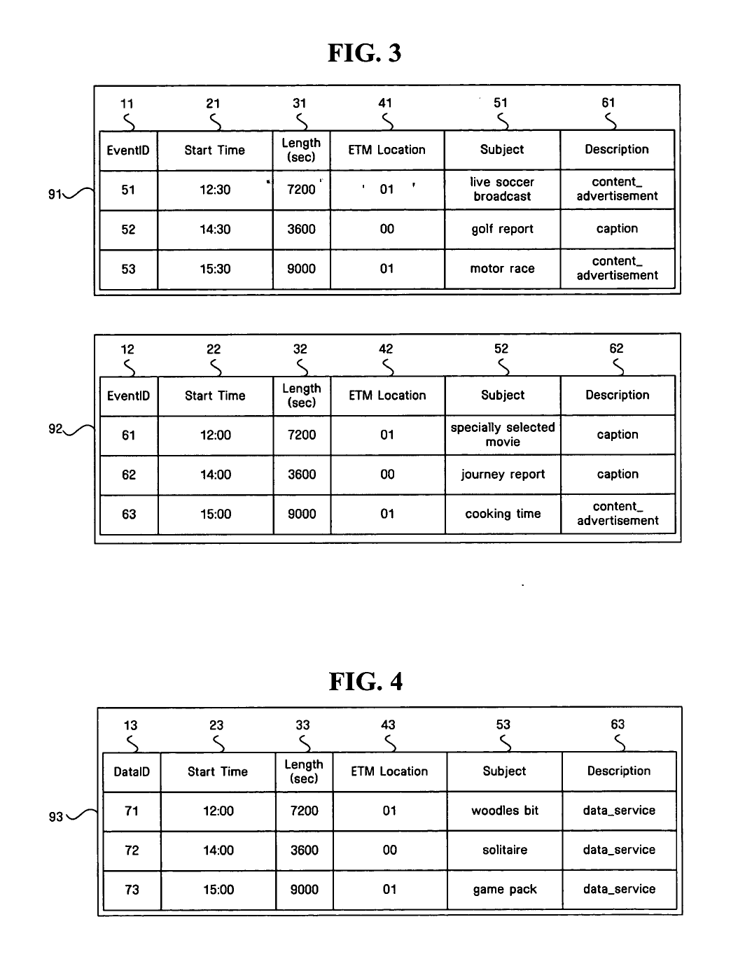

FIG. 3 shows a table detailing an example of extracting the reproduction time of digital broadcast content in accordance with the exemplary embodiment of the present invention.

In the following there is a description of a Program and System Information Protocol (PSIP), which is an example of a protocol for transmitting broadcast program information in a terrestrial DTV system. Event Information Tables (EITs) 91 and 92 include information about programs that are transmitted every 500 ms. The EITs 91 and 92 are lists of information about programs broadcasted for a single channel, and the example of FIG. 3 employs two EITs, which list information about programs that are broadcasted in the following three hours.

The EIT 91 includes information about an event identifier 11, a program start time 21, a program broadcast length 31, an Extended Text Message (ETM) location 41, a program subject 51, and a description 61. In this case, the program length 31 can be extracted and the set time of the screen saver can be changed based on the extracted information. For example, when a user views a live soccer broadcast from the beginning through a channel detailed in the EIT 91, the set time of the screen saver is set to 7200 seconds, that is, more than two hours, so that it is possible for the screen saver not to operate while the live soccer game is broadcasted.

The user can change the channel to another one while viewing the live soccer broadcast. When the user changes the channel to a channel detailed in the EIT 92 and views a specially selected movie, the set time of the screen saver can also be changed. If the user changes the channel at 13:00, the user can view the specially selected movie. However, since the specially selected movie content has progressed for one hour, it is preferable that the screen saver be set to one hour rather than two hours. Since the start times of programs can be acquired by the EIT and a current time can be seen, the remaining reproduction time of the content can be calculated. The calculated remaining time may be changed to the set time of the screen saver.

FIG. 4 shows a table that details an example of extracting the reproduction time of multimedia data in accordance with the exemplary embodiment of the present invention.

A digital broadcast provides a data service along with broadcast content. The screen saver can be controlled even while the data is used. In the case of data used along with an input device, such as a remote controller or a keyboard, an input signal is generated by the input device so that there is no need to change the set time when the interval of the generation of the input signal is shorter than the interval of the set time of the screen saver. In contrast, if the interval of generation of the input signal is longer than the interval of the set time, and if a user uses data via some other device that is not connected to a digital TV, or if the user input is not necessary, the set time of the screen saver may be changed. A Data Event Table (DET) 93 provides information about data service; the DET 93 includes an identifier 13, a start time 23, a data reproduction or usage time 33, an ETM location 43, and descriptions 63, similar to the EITs 91 and 92 of FIG. 3. Likewise, the set time of the screen saver can be changed by calculating the start time 23 and the data reproduction or usage times 33.

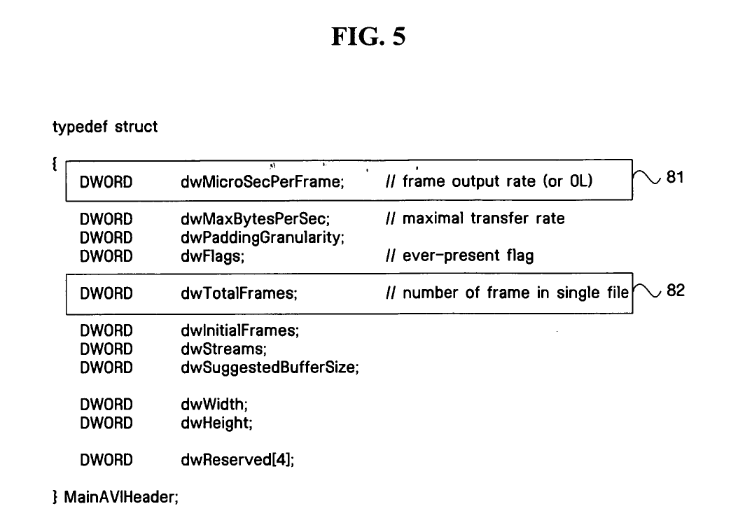

FIG. 5 is an example of extracting the reproduction time of multimedia content in accordance with the exemplary embodiment of the present invention.

The structure shown in FIG. 5 is MainAVIHeader, and is defined in an AVI header file. MainAVIHeader includes information about the total number of frames, the number of frames per second, and the maximum transfer rate. The entire reproduction time of the content can be obtained if the total number of frames is divided by the number of frames per second. In FIG. 5, since the total number of frames is dwTotalFrame 82 and the number of frames per second is dwMicroSecPerFrame 81, the total reproduction time can be obtained using dwTotalFrames/dwMicroSecPerFrame. Since this header information is included in the header of the AVI file, the total reproduction time can be determined using the reproduction time of the content.

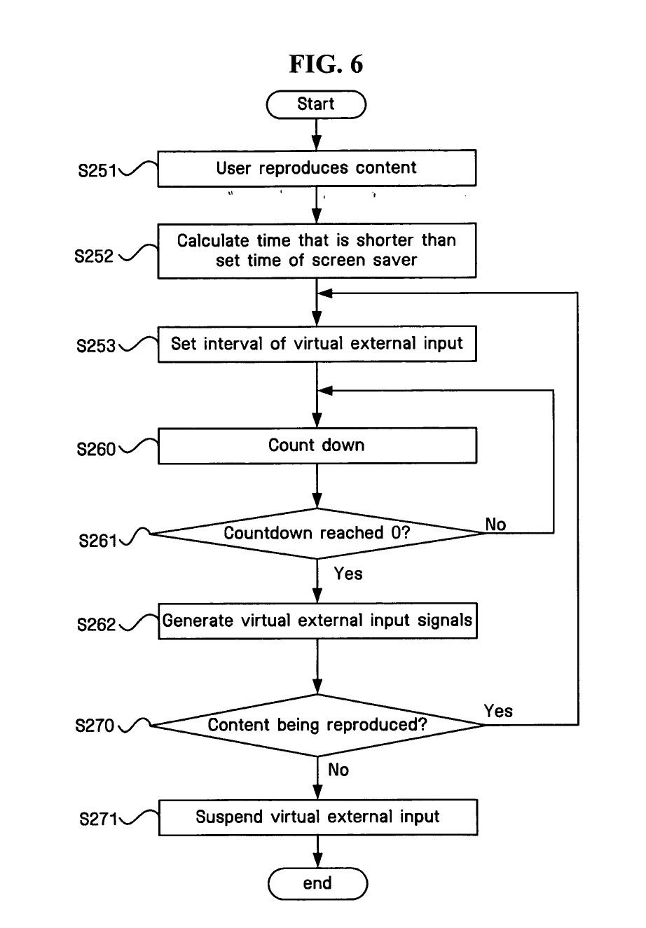

FIG. 6 is a flowchart illustrating a process of controlling the screen saver by generating a virtual external input signal during the reproduction of content in accordance with a second exemplary embodiment of the present invention.

The user reproduces content in operation S251. A reproduction device, such as a DTV or a Set-Top Box (STB), checks the set time of a screen saver and calculates a time shorter than the set time. For example, when the set time of the screen saver is 10 minutes, a time of 8 or 9 minutes is calculated in operation S252. The time is set as an interval for generating a virtual external input signal in operation S253. In this case, the external input signal is generated according to the set interval. Thereafter, the time set in operation S253 is counted down in operation S260. If the countdown reaches 0 in operation S261, the virtual external input signal is generated in operation S262. Even though the external input signal is not actually input by the user, it may be generated as though it was input by the user. The external input signal must be an input signal that does not disturb the user's content viewing. The signal may be, for example, a volume turn up/down signal, or a mute toggle input signal. Furthermore, the signal may be a virtual keyboard signal, or a virtual mouse signal. If the countdown does not reach 0, the countdown is continuously performed.

Thereafter, if the content is being reproduced in operation S270, the process starts from operation S253. In contrast, if the reproduction of the content is interrupted, the virtual external input is suspended in operation S271. When the reproduction of the content is interrupted, the screen saver operates according to the set time.

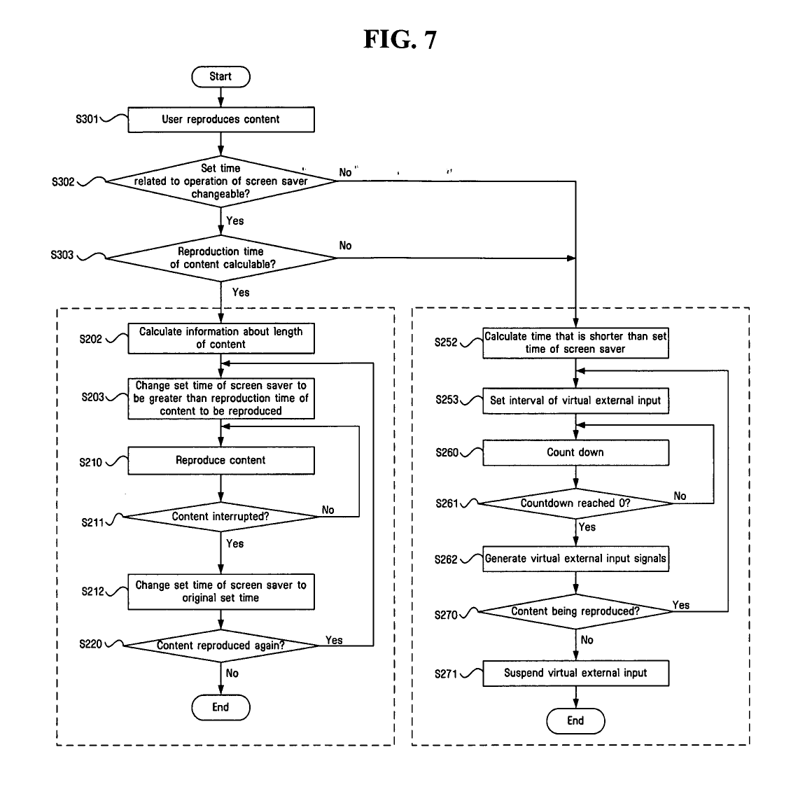

FIG. 7 is a flowchart illustrating the entire screen saver process according to the first exemplary embodiment of the present invention.

The method of controlling the operation of the screen saver described in conjunction with FIGS. 2 and 6 may be implemented by a single device. Furthermore, the method may be implemented by a single module, so that the method of FIG. 2 or 6 can be performed depending on whether the screen saver can be controlled, and whether the reproduction time of content can be extracted. A user reproduces content in operation S301. A multimedia device checks whether a set time related to the operation of the screen saver can be controlled in operation S302. In a specific multimedia device, it may be difficult to change the set time because the operation thereof has been predetermined. If the set time cannot be changed, the multimedia device allows the virtual input signal, which is described in conjunction with FIG. 6, to be generated. Accordingly, operations S252 to S271 are performed (refer to the descriptions of FIG. 6).

Meanwhile, although the set time of the screen saver can be changed, there is a case where the reproduction time of the content cannot be calculated. For example, if the content does not provide information about its reproduction time, or is reproduced by streaming, the reproduction time cannot be known. Accordingly, it is determined whether the reproduction time can be calculated in operation S303. If the reproduction time cannot be calculated, operations S252 to S271 are also performed.

If the set time of the screen saver can be changed and the reproduction time can be calculated, the operations of changing the set time, which are described in conjunction with FIG. 2, can be performed. Accordingly, operations S202 to S220 are performed. Descriptions of operations S202 to S220 will be replaced by the descriptions of FIG. 2.

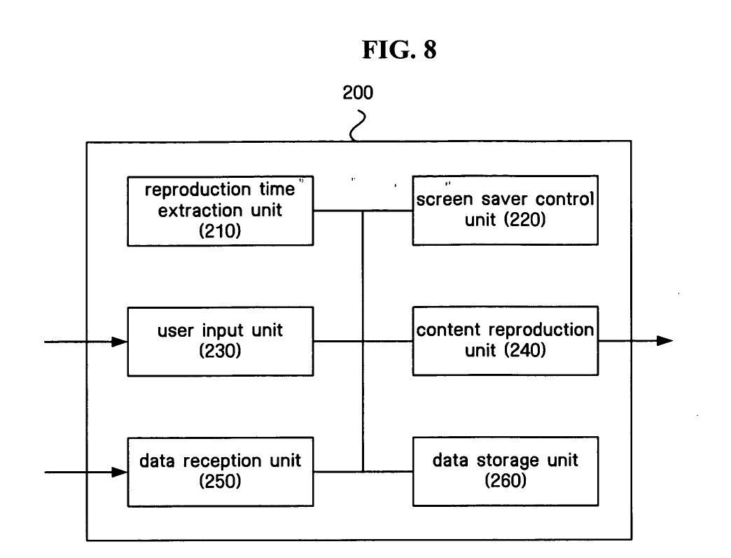

FIG. 8 is a block diagram showing the components of a multimedia device according to the exemplary embodiment of the present invention.

The terms “unit” and “module” refer to software and hardware, such as a Field-Programmable Gate Array (FPGA) or an Application-Specific Integrated Circuit (ASIC). The respective modules perform specific functions. The modules may be constructed to reside in an addressable storage media, or to operate one or more processors. Accordingly, as an example, the modules include components, such as software components, object-oriented software components, class components and task components, processes, functions, attributes, procedures, subroutines, segments of program code, drivers, firmware, microcode, circuits, data, databases, data structures, tables, arrays, and parameters. The components and functions provided within the modules may be combined into a smaller number of components and modules, or divided into additional components and modules. Furthermore, the components and modules may be implemented so as to operate one or more Central Processing Units (CPUs) within a device or a secure multimedia card.

The multimedia device 200 shown in FIG. 8 is a device, such as a digital TV, a digital STB, a notebook, or a computer, which has a function for reproducing multimedia content or receiving a digital broadcast. The multimedia device 200 according to the first exemplary embodiment of the present invention includes a reproduction time extraction unit 210, a screen saver control unit 220, a user input unit 230, a content reproduction unit 240, a data reception unit 250, and a data storage unit 260.

The reproduction time extraction unit 210 extracts a reproduction time from digital broadcast content received through the data reception unit 250, or from multimedia content stored in the data storage unit 260, and calculates the extracted reproduction time. Examples of calculating the extracted reproduction time in the reproduction time extraction unit 210 are shown in FIGS. 3, 4 and 5.

The screen saver control unit 220 sets a screen saver set time to be greater than the reproduction time based on the extracted reproduction time.

The user input unit 230 receives an input signal from a remote controller, a mouse, or a keyboard. Alternatively, the virtual input signal described in the descriptions of FIG. 6 may be generated. Accordingly, information about the screen saver set time set by the screen saver control unit 220 can be acquired, and the virtual input signal can be generated at intervals that are shorter than that of the set time.

The content reproduction unit 240 reproduces content received through the data reception unit 250 or the data storage unit 260. The reproduction time point can be paused or moved backward or forward in response to the input signal for interrupting the reproduction of the content; that is, pausing, reproducing, rewinding, or fast-forwarding the input signal is possible. In this case, the screen saver control unit 220 is provided with a notification that the reproduction has been paused, and therefore, causes the original set time of the screen saver to be restored so that the screen saver can operate according to the original set time. The screen saver is allowed to perform an original operation in such a way as to cause the user input unit 230 to stop the generation of the virtual input signal.

The data reception unit 250 receives the digital broadcast content. The received broadcast content is output through the content reproduction unit 240.

The data storage unit 260 stores the multimedia content. Furthermore, the data storage unit 260 may store content received in a streaming manner. The content stored in the data storage unit 260 is also output through the content reproduction unit 240.

In accordance with the present invention, the operation of the screen saver can be suspended during the reproduction of content.

In accordance with the present invention, the operation of the screen saver is suspended, and therefore, the interruption of a user's content viewing can be prevented.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of controlling operation of a screen saver during reproduction of content, the method comprising:
receiving an instruction to reproduce content;
determining whether the operation of the screen saver can be controlled;
calculating a reproduction time of the content if the operation of the screen saver is controllable; and
changing a set time of the screen saver so that the screen saver is not operated during the reproduction time.

2. The method of claim 1, wherein the determining if the operation of the screen saver can be controlled comprises determining whether the set time related to the operation of the screen saver can be changed, and whether the reproduction time of the content can be calculated.

3. The method of claim 1, wherein, if the content is digital broadcast content, the calculating the reproduction time of the content comprises performing a calculation using a start time of the content and the reproduction time of the content as parameters.

4. The method of claim 1, wherein, if the content is a multimedia file, the calculating the reproduction time of the content comprises extracting and calculating information stored in a header of the multimedia file.

5. The method of claim 1, wherein the changing the set time of the screen saver comprises changing the set time of the screen saver so that the set time is greater than the reproduction time of the content.

6. The method of claim 1, further comprising reproducing the content.

7. The method of claim 1, wherein the content to be reproduced is selected by a user.

8. The method of claim 6, further comprising restoring the set time of the screen saver to a value prior to the changing the set time if the reproduction of the content is interrupted after the changing the set time.

9. The method of claim 8, wherein, if the reproduction of the content is interrupted, the reproduction of the content is stopped, or a reproduction time point is moved forward or backward.

10. The method of claim 1, if it is determined that the operation of the screen saver cannot be controlled, the method further comprises:
extracting the set time of the screen saver; and
generating a virtual input signal at intervals of less than that of the set time of the screen saver so that the operation of the screen saver is suspended during the reproduction time of the content.

11. The method as set forth in claim 10, wherein the virtual input signal is generated by an input device.

12. The method as set forth in claim 11, wherein the input device comprises a remote controller, a mouse or a keyboard.

13. The method as set forth in claim 11, further comprising suspending the generation of the virtual input signal if the reproduction of the content is interrupted.

14. An apparatus for controlling operation of a screen saver during reproduction of content, the apparatus comprising:
a user input unit which receives an instruction to reproduce content;
a reproduction time extracting unit which calculates a reproduction time of the content;
a content reproduction unit which reproduces the content; and
a screen saver control unit which changes a set time of a screen saver if the reproduction of the content is interrupted so that the screen saver is not operated when the content is reproduced.

15. The apparatus as set forth in claim 14, wherein, if the content is digital broadcast content, the reproduction time extraction unit performs a calculation using a start time of the content and the reproduction time of the content as parameters.

16. The apparatus as set forth in claim 14, wherein, if the content is a multimedia file, the reproduction time extraction unit extracts and calculates information stored in a header of the file.

17. The apparatus as set forth in claim 14, wherein the screen saver control unit changes the set time of the screen saver so that the set time is greater than the reproduction time of the content.

18. The apparatus as set forth in claim 14, wherein, if the reproduction of the content is interrupted, the screen saver control unit restores the set time of the screen saver to an original value prior to changing the set time of the screen saver.

19. The apparatus as set forth in claim 18, wherein, if the reproduction of the content is interrupted, the reproduction of the content is stopped, or a reproduction time point is moved forward or backward.

20. An apparatus for controlling operation of a screen saver during reproduction of content, the apparatus comprising:
a user input unit which receives an instruction to reproduce content;
a content reproduction unit which reproduces the content; and
a screen saver control unit which operates a screen saver after there has been no input for a predetermined time;
wherein the user input unit generates a virtual input signal at intervals of less than that of a set time of the screen saver so that the screen saver is not operated while the content is reproduced.

21. The apparatus as set forth in claim 20, wherein the virtual input signal is generated by an input device.

22. The apparatus as set forth in claim 21, wherein the input device comprises a remote controller, a mouse or a keyboard.

23. The apparatus as set forth in claim 20, wherein, if the reproduction of the content by the content reproduction unit is interrupted, the generation of the virtual input signal is suspended.
